(19) United States
(12) Patent Application Publication
(10) Pub. No.: US 2024/0421626 A1
(43) Pub. Date: Dec. 19, 2024

(54) CONTROL SYSTEM TOOLKIT FOR DC POWER SYSTEMS

(71) Applicant: UNIVERSITY OF SOUTH FLORIDA, Tampa, FL (US)

(72) Inventors: Sagar Avinash Pandit, Tampa, FL (US); Manoj Kumar Ram, Tampa, FL (US); Arash Takshi, Tampa, FL (US)

(21) Appl. No.: 18/746,025

(22) Filed: Jun. 17, 2024

Related U.S. Application Data
(60) Provisional application No. 63/508,681, filed on Jun. 16, 2023.

(51) Int. Cl. H02J 7/00; H02J 7/34

(52) U.S. Cl. CPC H02J 7/007194; H02J 7/00309; H02J 7/0031; H02J 7/345; H02J 2207/50

(57) ABSTRACT

The present disclosure describes various aspects of devices and methods that are directed to systems for controlling power systems. A device comprises at least one power source unit having a plurality of physical unit pins, at least one sensor to measure a characteristic of at least one power source unit, and a microcontroller. The microcontroller comprises a memory with at least virtual unit object, at least one virtual sensor object, and a set of software instructions to cause the microcontroller to control the at least power source unit via at least one switch using a three-layer control scheme.

### CROSS REFERENCE TO RELATED APPLICATIONS

The present application is based on, claims priority to, and incorporates herein by reference in its entirety for all purposes, U.S. Provisional Patent Application Ser. No. 63/508,681, filed Jun. 16, 2023.

### STATEMENT OF GOVERNMENT SUPPORT

N/A

### BACKGROUND

Complex power systems can be modeled as hybrid dynamical systems having dynamic variables, such as voltages, currents, and temperatures etc., that evolve according to differential equations and make discrete transitions in a finite number of cases. There are many challenges associated with the analysis and predictions of behavior of such systems, as they are neither differentiable nor discrete. Full modeling of such complex systems as a way to determine control signals/actions for such systems has not achieved practical or widespread use, as doing so would an especially complex and computationally intensive task. And, for many systems, incorporating a processor having enough compute power as to be capable of performing such modeling would not be viable.

Thus, a need exists for an accurate, reliable, low complexity solution for modeling and controlling a hybrid system on a relatively inexpensive processing resource.

### SUMMARY

The present disclosure devices and methods are directed to systems for controlling power systems.

In some aspects, the present disclosure can provide a device that can include at least one power source unit having a plurality of physical unit pins. At least one sensor can be proximate to the at least one power source unit to measure a characteristic thereof and can generate a sensor signal indicative of the characteristic. A microcontroller can be connected to receive the sensor signal indicative of the characteristic of the at least one power source unit and can be connected to at least one switch of the at least one power source unit to provide a control signal to the at least one switch. The microcontroller may include a memory having stored thereon at least one virtual unit object. The at least one virtual unit object can include data representing a number of virtual unit pins. One or more virtual unit pin can store a current virtual unit pin state of a predefined set of possible virtual unit pin states. At least one virtual sensor object can include data representing at least one virtual sensor pin. The at least one virtual sensor pin can store at least one current virtual sensor pin symbol of a predefined set of possible virtual sensor pin symbols. A set of software instructions which, when executed by the microcontroller, can cause the microcontroller to control the at least one power source unit via the at least one switch using a three-layer control scheme. A composite state of the at least one power source unit can be determined. A value of the sensor signal can be read. A change of the composite state of the at least one power source unit can be determined, based on the sensor signal. The current virtual unit pin state of at least some of the virtual unit pins according to the change of the composite state can be set. A control signal can be outputted to the at least one switch based on the current virtual unit pin states of the number of virtual unit pins. The composite state and the change of the composite state can be determined according to a finite state machine implementing a transition function and a predefined number of composite states and composite symbols, reflecting characteristics of the at least one power source unit and the at least one sensor.

In another aspect, the present disclosure can provide a method of controlling at least one power source unit using a three-layer control scheme. A composite state of the at least one power source unit can be determined. A value of a sensor signal generated by at least one sensor, the sensor signal indicative of a characteristics can be read. A change of the composite state of the at least one power source unit, based on the sensor signal can be determined. A current virtual pin state according to the change of the composite state can be set. The current virtual pin state on at least one virtual sensor pin represented by at least one virtual unit object can be stored. A control signal to at least one switch configured to control a microcontroller connected to the at least one power source unit can be outputted. The composite state and the change of the composite state can be determined according to a finite state machine implementing a transition function and a predefined number of composite states and composite symbols, reflecting characteristics of the at least one power source unit and the at least one sensor.

These aspects are nonlimiting. Other aspects and features of the systems and methods described herein will be provided below.

### BRIEF DESCRIPTION OF THE DRAWINGS

The foregoing features of embodiments will be more readily understood by reference to the following detailed description, taken with reference to the accompanying drawings, in which:

FIG. 1 is a three-layer design of an example power circuit control system, according to some embodiments.

FIG. 2A is an example circuit diagram of a battery thermal runaway management circuit, according to some embodiments.

FIG. 2B is a block diagram illustrating an example configuration of the circuit and software of FIG. 2A, according to some embodiments.

FIG. 2C is a table with example state definitions for units and finite automaton, according to some embodiments.

FIG. 2D is an example transition function of a thermal runaway management system, according to some embodiments.

FIG. 3 is a diagram showing three levels associated with an example variable power buffer circuit, according to some embodiments.

### DETAILED DESCRIPTION

The detailed description set forth below in connection with the appended drawings is intended as a description of various configurations and methods, and is not intended to represent the only configurations or methods in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details. In some instances, well-known structures and components are shown in block diagram form to avoid obscuring such concepts.

As used in this specification and the claims, the singular forms “a,” “an,” and “the” include plural forms unless the context clearly dictates otherwise.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term and “substantially” and “significantly” will mean more than plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

The phrase “such as” should be interpreted as “for example, including.” Moreover, the use of any and all exemplary language, including but not limited to “such as”, is intended merely to better illuminate the systems and methods provided herein and does not pose a limitation on the scope of the systems and methods provided herein unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes one or more individual members. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

Direct current (DC) power systems can include different types of power source/power storage units, such as solar panels, wind turbines, batteries, and super-capacitors. In some instances, the power sources can be combined to produce or discharge electricity for various environments and applications, such as a microgrid environment or a specific load. The system can be designed to use the available power sources efficiently, which can result in cost savings and reduced environmental impact. In some systems, the power sources, loads, and electrical components can interact to form a dynamical system.

The voltage and current levels in the system may be affected by various factors, such as changes in the load, variations in the input voltage, and faults in the system. In some examples, dynamical systems can be modeled as hybrid dynamical systems, which can account for the interaction of continuous and discrete dynamics. The continuous dynamics in a power system may refer to the behavior of the electrical signals that flow through the system, which are modeled by differential equations. The signals can vary continuously over time, and their behavior may be affected by the electrical components in the system, such as resistors, capacitors, and inductors.

To regulate voltage levels and maintain stability, a control system can be used to generate one or more control signals that can affect or change the operation of the system. Thus, the ‘discrete’ dynamics in a power system may refer to the switching behavior of the electrical components, which are modeled by logic rules. These components can be switched on and off, depending on certain conditions such as the voltage, current levels, or temperature in the system. Switching can be done on a per unit basis (e.g., for each individual power source) or in a coordinated way to control overall properties of a power system as a whole. These switches can affect the behavior of the continuous dynamics, resulting in abrupt changes.

In general, some implementations of control system on a microcomputing device may involve modeling the system as a finite state machine (FSM). An FSM is a mathematical model of a system that may start with a predetermined “state,” read a sequence of input symbols, and produce a sequence of “states.” The FSM can include a set of states, and transitions between states, where one or more transitions can be associated with a specific input symbol. The FSM can be described by a set of transition rules, which determine the output based on the current state and input symbol.

The systems and methods provided herein can build layers and provides components to model the hybrid dynamical system as an FSM using the following assumptions: (1) A practical implementations of hybrid dynamical system that discretize time to create a discrete time hybrid dynamical system (DTHDS); (2) as a consequence of the assumption 1 the “states” accessible to the system may also be finite and discrete; and (3) the sensor inputs can be used with threshold values to make discrete jumps and can provide a finite number of discrete threshold points

The present disclosure is directed to several aspects of systems and methods that can make practical use of these concepts. In one sense, the disclosure contemplates hybrid dynamical systems that incorporate a microcontroller programmed to leverage the modeling and control features of this disclosure to control the system in regard to a given attribute or action (e.g., to mitigate thermal runaway) or multiple attributes/actions. In another sense, the disclosure contemplates methods, software applications, user interfaces, and software generation systems for flexible and modular approaches to developing software to run such a microcontroller.

Such systems and methods disclosed herein can be made from, or implement, an approach to providing modular hardware-software building blocks to model a hybrid system in a far less complex way than previously existed. By modeling certain states of a hybrid system, a finite state machine (or similar discrete decision-making or function-implementing construct) can be used to model enough of the system to practically operate on a microcontroller platform without the need of high compute power. This approach can be thought of as comprising multiple layers of high and low-level functions merged into a single software approach, such as two or three layers.

A higher order layer may be implemented to model a hybrid dynamical system as a FSM. In other words, the top-level decision making layer of this approach need not consider the specific voltage, current, digital value, temperature, etc. of all points or nodes within a system, but instead can consider overall ‘composite’ states of the system relevant to the aspects of the system to be controlled. In some embodiments, these ‘composite’ states are the only states that are modeled at the top-level.

A middle layer (or in some configurations, the bottom layer) can be designed using modular building blocks, which represent both the active circuit elements (and the states of their inputs/outputs/electrical characteristics) as well as sensors monitoring characteristics of the circuit. The middle (or bottom) layer can provide a logical framework for describing the state of active elements in a circuit (denoted by the term “Unit” in the context of the examples described below) and allows for communication from the top-level, decision-making layer to hardware-level inputs/outputs. For modeling Sensors, the middle layer provides a discrete and finite number of symbolic outputs from sensor elements of the circuit. In other words, actual sensor values need not be considered by the top-level, or even the middle-level; instead, symbols discretizing and summarizing sensor values to information pertinent to the decision-making implemented by the FSM can be used. In this fashion, the middle layer avoids substantial complexity in a way intelligently focused on the aspects of the circuit states relevant to the control decisions made by the top-layer.

A hardware layer may also be utilized as the ‘bottom’ of three layers. The hardware layer can provide logical building blocks of the digital and analog communication channels to the physical hardware (denoted as “Pins” in the examples below). Thus, the hardware layer can transform ‘states’ of the Units from the middle layer into actual signals, voltage levels, etc. to be imposed on the pins of the active circuit elements. The hardware layer can also transform sensor readings and actual real-world characteristics of the circuit into the discretized/summarized information pertinent to decision making. For example, the hardware layer may employe filtering, thresholding, averaging, and other signal processing techniques to make determinations about sensor output. If output of a temperature sensor monitoring a given power storage unit is less than 200° C., the hardware layer can receive and process that value using a thresholding function and output a binary value to the middle layer that the temperature is “Acceptable,” since a threshold of safe operation before thermal runaway for the power storage unit might be around that temperature. Correspondingly, if the output of the temperature sensor is over 200° C., then the hardware layer may output a binary value to the middle layer that the temperature is “High.” It should be understood that temperature of a power storage unit may be relevant for a variety of reasons beyond merely assessing potential thermal runaway, such as the impact temperature may have on optimal performance, energy storage, energy output, etc. However, an advantage of the approaches described herein is that the three-layer modeling can distill sensor output into discretized information that can be abstracted into a top-level decision making function, thereby reducing complexity while maintaining accurate functionality for the specific control action being implemented.

Thus, the examples below may leverage simple building blocks, or object cores, to design and control DC power circuits. The building blocks can be thought of as memory objects that can be tailored to the specific pin mappings of individual active circuit elements and the specific connections of those pins in a given circuit design. The building blocks may include elements operable within a three-layer modeling and control approach: the top-level decision making layer may utilize a finite state machine or other discrete function-implementing block; the middle layer may utilize Unit and Sensor memory objects having data stored in specific “pins” (which may map to actual physical pins, though not necessarily in a surjective nature and there may be more memory object “pins” than actual physical pins); and the lower/hardware layer may comprise low level function elements (e.g., thresholding, binning, filtering, etc.) to transform actual sensor outputs into useful data elements and to transform pin “setting” information from the middle level to hardware pins (e.g., “Low” to logical 0V) and vice versa.

Conceptually, the building blocks are multi-layer functions and objects that run on microcontroller units (such as but not limited to Arduino) and control the circuit elements through the pin connections on the device. The top level of hierarchy provides a means of modeling DC power system as hybrid dynamical system through the decision-making function of the FSM. The middle layer provides memory-based blocks for “active units” and “sensors”. The lower level provides virtual state information/control to/from the hardware so that the system can adaptably run on various controller devices.

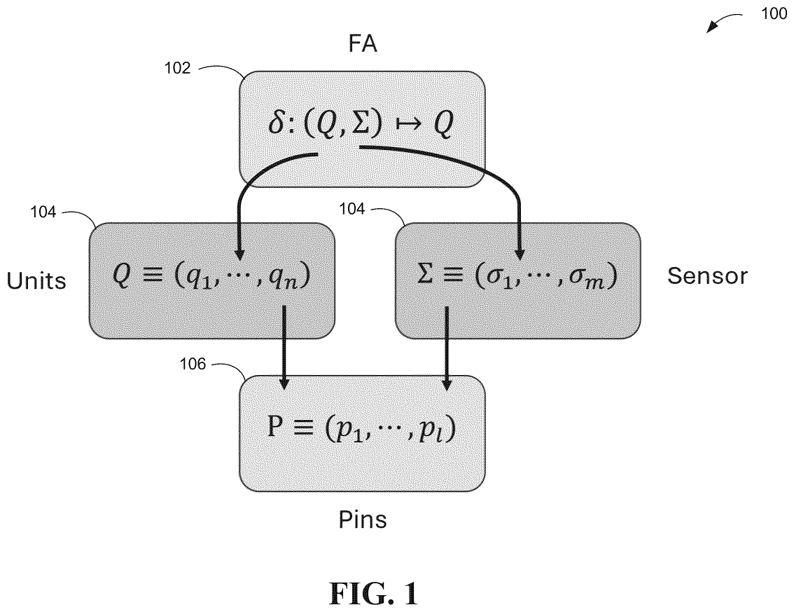

Turning to FIG. 1, the overall design of an example control system 100 is illustrated. The system 100 can be divided into three layers, with a top most layer 102, a middle layer 104, and a bottom most layer 106. In some examples, the top most layer 102 can be a direct implementation of the FSM and the bottom most layer 106 establishing a direct connection to switches and sensors in a DC power system through a tightly integrated microcontroller hardware layer. As seen in FIG. 1, the system 100 can be designed to control the activities of multiple independent “Units” (e.g., power source units), one or more of which can contribute to the overall state of the system. By combining the individual states of these “Units”, the system 100 can use software to generate a composite state that reflects the current status of the system 100 as a whole. In some examples, the composite state can include a set of states (Q) for the FSM. Further, inputs from various “Sensors” can be discretized and combined to form a quantity belonging to the set of symbols (Σ), that is used by the transition function δ: Q×Σ→Q which, in part, defines the decision making and functionality of the FSM. For example, the inputs from various sensors may include sensor signals indicative of characteristics measured from the units. In some examples, the system may evolve in time as a repeated action of the transition function δ. The system 100 can allow for greater flexibility and scalability, as the system 100 can adapt to changes in its environment or requirements by adjusting the states of its constituent units.

The top layer 102 can be provided in the formulation of an FSM, which models the DTHDS. The FSM itself need not be implemented as a traditional ‘class.’ In some examples, class constructors can involve making copies of constituent objects, but by using a more primitive construct, the top layer 102 can achieve an improved efficiency. The FSM construct can contain pointers to the Unit and Sensor memory object blocks (of which there may be more than one per category) along with their lengths as an integer (int). In some examples, the composite states and symbols used in the FSM may be enumerated as simple integers. Thus, an enum can be established, specific to each set-up, which addresses the composite states and symbols. Further, the FSM can also include an integer for a number of composite states and a number of composite symbols. In some examples, the transition function δ can be defined as a function pointer to a function of type [symbol] × [symbol] [symbol] [symbol] . Along with the static data, a finite automaton (FA) structure can have the following external functions: (1) Construct_FSM: An external constructor which may not allocate new memory and constructs pointer copies the objects in the construct FSM; (2) Units_states: A mapping function used to translate a composite state into an array of individual states of the units. Current implementation of this function may follow a method similar to binary digit encoding; (3) Sensors_symbols: A mapping function to translate a composite symbol into an array of individual symbols of the sensors. Current implementation of this function can follow a method similar to binary digit encoding; and (4) Commit: A function to decompose a composite state and propagate application of the corresponding individual states for one or more units. This function can propagate state changes down to the hardware level. In some examples, the transition function can be a decision table that can be implemented efficiently Moreover, by allowing a user to define their own 8, the system can provide a machine learnt decision table with increased flexibility and potentially increased complexion.

The middle layer 104 can include formulations for the units and sensors. In some examples, the units are made up of number of “pins” (e.g., unit pins). Each pin can have two states if it is a “digital” pin, or a finite number of discrete states if it is an “analog” or “virtual” pin. Thus, the state of a unit may be a combination of states of the individual pins forming the unit. The set of the states of a unit can also form a smaller subset of possible combinations of the pin values. The class “Unit” can include the following data elements: (1) no_pins: a number of pins defining the object “Unit”; (2) no_states: a number of states the “Unit” object has; (3) an array of length no_pins of objects “Pin” holding the current state of individual pin which can be read and written; (4) states: provides the table establishes mapping between individual pin states and the state of a “Unit”; and (5) state_names: holds the array of user assigned names for the states. Moreover, the class “Unit” can also include the following method elements: (6) The constructors: the constructor allocated the array for pins and initializes number of pins and sets number of states to zero, the unit is created without specific definitions of states (this method does not affect the physical elements); (7) Activate: the activate method establishes connection with the logical “Unit” and the physical unit, this method affects the physical elements; (8) No_States: a selector function that returns the value of number of states (note that No_states does not return variable by address; this method does not affect the physical elements); (9) add_state: this method takes an array of pin values and string for the state name and creates a new entry in the states table and increments the number of states by one (this method does not affect the physical elements); (10) set_state: for the argument state the function chooses entry in the states table to sets up the corresponding pin states to realize the logical state. (this method affects the physical elements); (11) get_state: returns the current state of the “Unit” as a row index in the states table (Also returns the address of a string holding the state name in the argument list. If a pin is declared as analog but the physical pin on Arduino device is digital, then behavior of this method is unreliable. This method depends on the physical elements.); (12) State_name: returns the name of a state (this method does not affect the physical elements).

Similar to the units described above, the sensors are also made up of different types of pins. Sensor objects can return a symbol (of type integer) based on the status of the constituent pins and the logic function. The class “Sensor” can include the data following data elements: (1) no_pins: number of pins defining the object “Sensor”; (2) no_symbols: number of symbols the object “sensor” produces (3) pins: array of length no_pins of objects “Pin” holding the current state of individual pin which can be read; and (4) convert_to: function pointer of type logic (The function pointer hold function that maps an array of pin_values onto Σ. e.g. Suppose the sensor measures water level and records it as pin_value between 0 and 10 then convert_to can return 0, 1, 2 corresponding to say low, medium, high water level values based on some predetermined thresholds. Thus convert_to does not return pin_values but corresponding logical construct.). Moreover, the class “Sensor” can also include the following method elements: (5) The constructors: the constructor allocated the array for pins and initializes number of Pins. (This sets number of symbols to zero. The sensor is created without specific definitions of symbols. This method does not affect the physical elements.); (6) Activate: the activate method establishes connection with the logical “Sensor” and the physical sensor unit (This method affects the physical elements); (7) No_Symbols: selector function that returns the value of number of symbols (Note: No_Symbols does not return variable by address. This method does not affect the physical elements.); (8) add_symbol: this method takes a string for the symbol name and creates a new entry in the symbols table and increments the number of symbols by one (This method does not affect the physical elements.); and (9) read_sensor: this method readings in the pins forming the sensor and based on the pin values determines the output symbol using the convert_to function (This method depends on the physical state of the physical sensors in the system.).

The lower layer 106 of the design can provide formulations for the hardware and may be tightly integrated with the microcontroller hardware. In some examples, the microcontroller may be connected to at least one switch from corresponding to one or more units. In some examples, the lower layer 106 can define an object “Pin,” which corresponds to a communication channel that controls physical elements. Thus, the objects described in top and middle layers 102, 104 may not directly make changes to the hardware, but are achieved through various calls to the “Pin” object. At a software level, the “Pin” object may be one of three kinds: a “digital pin,” “analog pin,” and “virtual pin.” Note: in some cases, not all controller hardware provides each type of communication channel in physical space. Thus, the formulation corresponds to the underlying controller hardware in some embodiments.

In some examples, the pin objects are formulations of the pin connections implemented as a C++ class. The data characteristics of the lower layer 106 can include the following data and methods: (1) id: one or more pins are uniquely identified using an unsigned short denoted by id (The virtual id of the pin is mapped onto the physical pin number by the constructor of this.); (2) val: holds value associated with a pin (It is of C++ union type pin_value, which stores either a single precision float or an unsigned short value depending upon the type of the pin under consideration. A digital pin can have values 0 and 1 thus can use unsigned short, whereas the analog and virtual pin types store continuous values.); (3) type: type of the pin) Pin_type is an enumerated C++ type which enumerates “analog,” “digital” and “virtual” pin types.); (4) func: ADC function pointer which converts a float to int; (5) ifunc: DAC function pointer which converts an int to float; (6) The constructors: constructors copy the contents of the Pin object including the function pointers for analog-to-digital conversion (ADC) and digital-to-analog conversion (DAC) functions (These methods do not alter the physical state of the communication channel.); (7) Activate: the activate method establishes connection with the logical “Pin” and the physical communication channel (This method affects the physical elements.); (8) set_values: this method initializes pin to value zero and sets correct pin type and ACD/DAC function pointers (This method does not affect the physical state of the communication channel.); (9) Val & Type: the selector methods that return (and set) the value and type associated with a pin (Note that this method does not query the physical channel. The return value of Val is simply the stored value in the data element val. These methods do not affect the physical channel.); (10) set: the overloaded set methods update values stored in val and depending on pin type appropriately commit the changes to the physical layer (These methods affect the physical elements.); and (11) get: the get method queries the hardware and whenever possible gets the value for the pin (This method depends on the physical elements.).

### Examples Embodiments and Applications

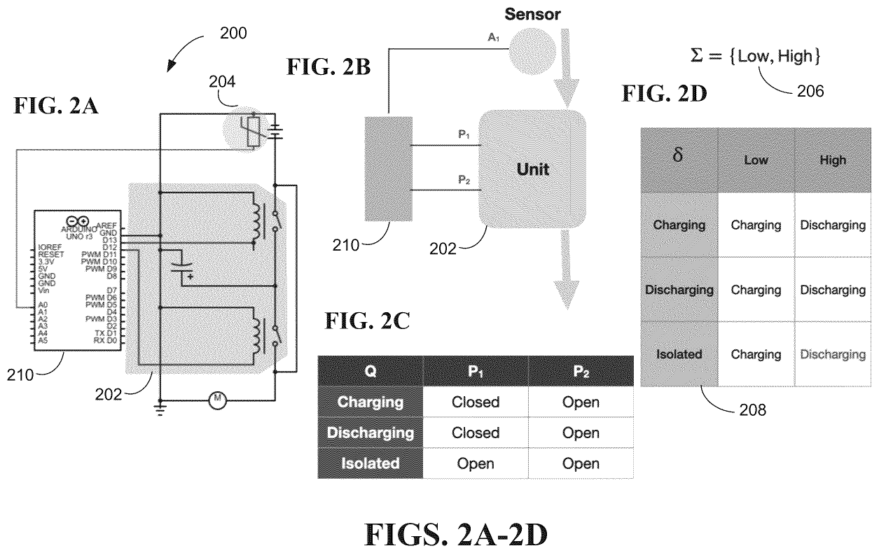

Thermal Runaway: Now referring to FIGS. 2A-2B, an example circuit diagram 200 and the corresponding logical layout of an example software design are illustrated. In some examples, including the one depicted, a system might include one or more power source units (e.g., batteries or supercapacitors) that are susceptible to thermal runaway conditions. Thus, a circuit is desirable for controlling certain aspects of the power source unit, to prevent, mitigate, or stop thermal runaway conditions.

In FIG. 1A, a circuit design 200 is shown for preventing thermal runaway. The circuit design includes one power source unit 202 and one sensor 204, though it should be understood that more complex systems having multiple power source units and/or multiple sensors are contemplated and could be controlled by the same or a similar microcontroller 210. As shown, the circuit 200 has an input lead or trace electrically connecting a physical pin of the microcontroller 210 to a physical pin of the sensor 204. The battery 202 also comprises a number of input and output pins, including some pins which are electrically connected via leads, wires, or traces to output pins of the microcontroller 210 so that the microcontroller can send control signals to switches or relays of the circuit 200 (or of the battery 202) to affect the state of the battery relevant to thermal runaway conditions.

In FIG. 2B, a conceptual abstraction of the circuit diagram is shown, to illustrate how information regarding the circuit would be stored in the microcontroller's memory. In this case, one Sensor object and one Unit object are stored, as well as information regarding their pin connections to the microcontroller, A1, P1, and P2.

Referring now to FIG. 2C, a mapping table is show, depicting how the microcontroller's three-layer modeling approach would map a higher level, “composite” state to lower-level pin states. Here, the three-layer software running on the microcontroller could translate information regarding the high/low digital values of the pins P1 and P2 of the power source Unit into composite states: when P1 is a given logical value (e.g., ‘Closed’) and P2 is the opposite logical value (e.g., ‘Open’), the circuit can be understood as in a “Charging” state or a “Discharging” state; when both P1 and P2 are the same given logical value (e.g., ‘Open’), the circuit can be understood as being in an Isolated state.

Referring now to FIG. 2D, the highest-level layer (e.g., of a FSM) is conceptually represented. Assuming that an output of the physical sensor 204 has been discretized to give only the information relevant to assessing thermal runaway (e.g., the output value has been thresholded to be ‘Low’ or ‘High’), then the FSM can be thought of as having a defined set of state transitions. A transition function and corresponding table may be developed based on the units, sensors, and/or corresponding symbols. For example, FIG. 2D illustrates a transition function 208 of a finite state machine for the thermal runaway management system of circuit diagram 200. Here, a user may define the appropriate transitions for the circuit to make based on the specific type of power source and desired mitigation strategies. For example, the FSM may determine that the battery is in a Charging state, based on values of P1 and P2 which are set according to the load or other software or circuit element. If the low level layer detects a low or acceptable temperature value, it may report a “Low” value to the middle layer. The FSM may then determine this sensor state as a composite state, and decide that the circuit should remain in the Charging state. As another example, if the circuit was in an isolated state but experienced a high temperature, it may be desirable to generate a control signal from the microcontroller to force the circuit to enter the Discharging state (depending upon the nature of the battery and chosen temperature threshold).

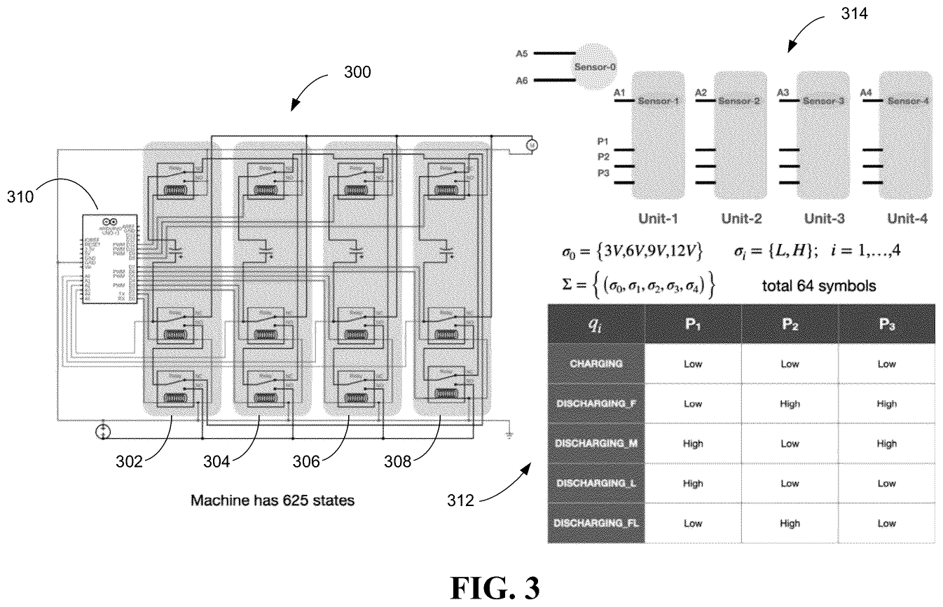

Variable Voltage Power Buffer Using SCAP: Now referring to FIG. 3, an example circuit diagram 300 is shown, illustrating the layout of a variable voltage power buffer circuit comprising four-supercapacitors 302, 304, 306, 308. A microcontroller 310 is connected via a number of wires, leads, or traces to voltage sensors to receive information about the state of the circuit at various pins of the power source units (supercapacitors). The microcontroller 310 is also connected via a number of electrical connections to a number of switches of the supercapacitors 302-308, to affect the state of the supercapacitors (which may be, e.g., discharging in series, discharging in parallel, charging, or ‘off”).

In some examples, the power buffer circuit controlling software of microcontroller 310 can operate by assuming the SCAPs have a large power density, and need not all be switched on or off together. Thus, the overall circuit 300 may have composite states that are determined by individual states of the SCAPs. Thus, physical pin states may map to virtual primitive pin states, actual sensor values may be mapped to virtual primitive symbols (e.g., “Adequate Voltage” or “Inadequate Voltage”, or specific binned voltage values). The virtual primitive pin states can map to Unit states, as shown in table 312, and Unit states can define composite states. As shown in diagram 314, the four voltage sensors report charge state of the capacitors. The three-layer control approach will cause a state transition of the system based upon one of the 64 possible Sensor unit symbols.

Thus, at the highest level, a FSM may implement transition functions associated with the circuit diagram 300, which may be designed to ensure that the SCAPs perform in coordination appropriate to their chemistry/functionality and the overall goals of the circuit 300. For example, the FSM may ensure that only some SCAPs charge in parallel at a lower voltage, or that some or all of the SCAPs discharge in a serial sequence in order to provide a higher voltage when necessary. In some examples, the arrangement can ensure that other SCAPs in the design are charged if full redundancy is available. In further examples, the arrangement may be a token ring-type, if partial redundancy is available.

Design Interface. In another sense, the present disclosure provides for a method and/or software interface allowing a user to design a control application to be run on a chip to control a DC power system. The method may receive as inputs a number of power storage units (to define the number of memory Unit objects); a number of sensors (to define the number of virtual Sensor objects); a model name or pin information of a microcontroller; pin connection information relating the pins of the microcontroller to pins of the power storage unit switches/actuators and pins of sensor outputting the sensed signal; and a state transition function. From this, Unit objects may be formed by the method and placed in the microcontroller memory with delineated memory space to account for the pin states of the pins of the Unit being monitored and/or controlled. Likewise Sensor objects may be formed in a similar manner. In some embodiments, a user may also define the possible sensor ‘symbols’, such as by defining the states of the sensor readings that are pertinent to the behavior of the circuit to be controlled.

The lowest layer of a three-layer control application can be automatically generated, by implementing a number of functions to be performed on signals received at the pin(s) of the microcontroller connected to receive sensor signals and/or to generate suitable control signals or pin setting signals to be output to the Unit(s)

The middle layer of the three-layer control application can be automatically generated by allocating in memory a number of Unit objects and Sensor objects, having defined lengths corresponding to the amount of memory needed to store pin states. The lowest layer functions will be given pointers to specific pin state memory locations to set the virtual pin states according to the detected physical pin states and vice versa. Likewise, the lowest layer functions will be given pointers to specific memory locations of the Sensor objects to update Sensor virtual pin states according to the discretized sensor readings.

The top layer of the three-layer control application can be automatically generated as an input-reactive function that updates among various defined, discrete states in the manner of a finite state machine. The FSM may be determined according to the user-provided transition function, or may be predefined based on common functions (e.g., mitigating thermal runaway, etc.). The FSM may be given pointers to virtual pin settings of all of the virtual pins of the Unit objects and Sensor objects. Or, an intermediate mapping function may translate the virtual pin settings of the Unit objects to composite states of the system and the FSM may be given pointers to the current composite state of the system.

The FSM may be initialized to a given composite state based upon the lowest layer reading physical pin attributes, converting those to virtual pin states, then the middle layer aggregating those virtual pin states into composite states. As Sensor symbols are updated at the FSM's pointer locations, the FSM may output a command to alter the system to enter a different composite state. This may be accomplished by forcing one or more virtual Unit pin settings to change, according to a desired composite state, by setting new values at the appropriate pointer locations.

The middle layers will then temporarily reflect a different state than the physical state of the circuit. The lower level layer may be automatically programmed to be triggered, by detecting the change in the middle layer, to cause physical pin state changes to cause the circuit to enter the composite state (e.g., the lower level layer may output a control signal or set a pin to a given value to cause a switch to open or close).

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. A device comprising:
at least one power source unit having a plurality of physical unit pins;
at least one sensor positioned proximate to the at least one power source unit to measure a characteristic thereof and generate a sensor signal indicative of the characteristic;
a microcontroller connected to receive the sensor signal indicative of the characteristic of the at least one power source unit, and connected to at least one switch of the at least one power source unit to provide a control signal to the at least one switch;
wherein the microcontroller comprises a memory having stored thereon:
at least one virtual unit object comprising data representing a number of virtual unit pins, each virtual unit pin storing a current virtual unit pin state of a predefined set of possible virtual unit pin states;
at least one virtual sensor object comprising data representing at least one virtual sensor pin, the at least one virtual sensor pin storing at least one current virtual sensor pin symbol of a predefined set of possible virtual sensor pin symbols; and
a set of software instructions which, when executed by the microcontroller, causes the microcontroller to control the at least one power source unit via the at least one switch using a three-layer control scheme, including the following actions:
determine a composite state of the at least one power source unit;
read a value of the sensor signal;
determine a change of the composite state of the at least one power source unit, based on the sensor signal; and
set the current virtual unit pin state of at least some of the virtual unit pins according to the change of the composite state; and
output a control signal to the at least one switch based on the current virtual unit pin states of the number of virtual unit pins;
wherein the composite state and the change of the composite state are determined according to a finite state machine implementing a transition function and a predefined number of composite states and composite symbols, reflecting characteristics of the at least one power source unit and the at least one sensor.

2. The device of claim 1, wherein each physical unit pin of the at least one power source unit is mapped to a virtual unit pin of the at least one virtual unit object.

3. The device of claim 2, wherein the plurality of physical unit pins of the at least one power source unit map to a subset of the virtual unit pins of the at least one virtual unit object.

4. The device of claim 1, wherein the finite state machine comprises an encoder mapping the current virtual unit pin states to the composite state of the at least one power source.

5. The device of claim 4, wherein the encoder is a BID encoder.

6. The device of claim 1, wherein the at least one sensor is a temperature sensor monitoring a thermal characteristic of the at least one power source unit.

7. The device of claim 6 wherein the predefined number of composite states includes:
a charging states corresponding to a first power source unit being in a closed position and a second power source unit being in an open position;
a discharging state corresponding to the first power source unit being in the open position and the second power source unit being in the closed position; and
an isolated state corresponding to the first power source unit being in the open position and the second power source unit being in the open position.

8. The device of claim 7, wherein the control signal comprises an actuation signal to prevent thermal runaway, the actuation signal configured to open and close a first switch connected to the first power source unit and a second switch connected to the second power source unit.

9. The device of claim 1, wherein the at least one sensor is an electrical sensor configured to measure at least one of: a current, a voltage, or a power value associated with the at least one power source unit.

10. The device of claim 9, wherein the at least one power source unit comprises two or more power supply units (PSUs).

11. The device of claim 10, wherein the microcontroller is configured to switch the two or more PSUs between an off state, an on state, a series state, and a parallel state based on the predefined number of composite states.

12. The device of claim 10, wherein the at least one virtual unit object is a modular memory construct mapped to a plurality of pin definitions of the two or more PSUs and the microcontroller.

13. A method of controlling at least one power source unit using a three-layer control scheme, the method comprising:
determining a composite state of the at least one power source unit;
reading a value of a sensor signal generated by at least one sensor, the sensor signal indicative of a characteristics;
determining a change of the composite state of the at least one power source unit, based on the sensor signal;
setting a current virtual pin state according to the change of the composite state;
storing the current virtual pin state on at least one virtual sensor pin represented by at least one virtual unit object; and
outputting a control signal to at least one switch configured to control a microcontroller connected to the at least one power source unit;
wherein the composite state and the change of the composite state are determined according to a finite state machine implementing a transition function and a predefined number of composite states and composite symbols, reflecting characteristics of the at least one power source unit and the at least one sensor.

14. The method of claim 13, further comprising mapping a physical unit pin of the at least one power source unit to a virtual unit pin of the at least one virtual unit object.

15. The method of claim 13, further comprising:
monitoring a thermal characteristic of the at least one power source unit; and
determining the change of the composite state based on the thermal characteristic.
